(19) United States
(12) Patent Application Publication
(10) Pub. No.: US 2013/0188888 A1
(43) Pub. Date: Jul. 25, 2013

(54) ENVIRONMENTAL-PROTECTION KITCHEN-WASTE COMPOSTING BAG

(71) Applicants: Chin-Min LIU, Zhubei City (TW); Hsueh-Chih LIU, Zhubei City (TW)

(72) Inventors: Chin-Min LIU, Zhubei City (TW); Hsueh-Chih LIU, Zhubei City (TW)

(21) Appl. No.: 13/659,388

(22) Filed: Oct. 24, 2012

(30) Foreign Application Priority Data
Jan. 19, 2012 (TW) 101201352

(51) Int. Cl. B65F 1/00; B65F 1/02; B65F 1/14

(52) U.S. Cl. 383/25; 383/38

(57) ABSTRACT

An environmental-protection kitchen-waste bag comprises a bag and a partition line. The bag has an opening. At least one first open/close member is arranged on the opening for opening or closing the opening. The partition line partitions the bag into a kitchen-waste compartment accommodating kitchen waste and a liquid compartment positioned below the kitchen-waste compartment and receiving kitchen-waste water. The partition line has at least one first hole allowing water in the kitchen-waste compartment to flow into the liquid compartment. The present invention can effectively separate water from kitchen waste. During fermentation, the present invention can recycle kitchen-waste water. The recycled kitchen-waste water is recharged to kitchen waste to accelerate fermentation, whereby kitchen waste is fermented more fully.

### BACKGROUND OF THE INVENTION

1. Field of the Invention

The present invention relates to a kitchen-waste composting bag, particularly to an environmental-protection kitchen-waste composting bag able to separate water from kitchen waste.

2. Description of the Related Art

Recycling kitchen waste is mainly to compost kitchen waste into manure, in addition to reducing the garbage amount, decreasing the garbage processing cost, and preventing the kitchen waste in garbage from stenching. Kitchen waste normally contains a lot of water. Water in kitchen waste increases the volume and weight of garbage, accelerates the stenching of kitchen waste and is likely to leak and pollute the environment. If kitchen waste is to be recycled and fabricated into manure, the water thereof should be removed beforehand. Thus is increased an additional procedure. If kitchen waste is to be solarized into compost or buried underground, the abundant water in kitchen waste is likely to leak and pollute groundwater. If kitchen waste is to be incinerated, the great amount of water in kitchen waste would increase the burden of the incinerator.

Therefore was developed a composting tank able to filter water from kitchen waste. Refer to FIG. 1. While kitchen waste is poured into the composting tank 50, the filter 52 inside the composting tank 50 filters water from kitchen waste. A faucet 54 is installed near the bottom of the composting tank 50 and used to drain kitchen-waste water off. The kitchen-waste water is recycled and poured back to the composting tank 50. The recycled kitchen-waste water can accelerate fermentation of kitchen waste. Alternatively, the recycled kitchen-waste water is directly used as liquid manure. The liquid manure is diluted to function as plant fertilizer. However, the composting tank needs many components and complicated assembly procedures. Besides, the composting tank is a rigid and bulky casing, which occupies space and lacks sufficient airtightness. Therefore, the smell of kitchen waste is likely to leak out. Further, the composting tank is opaque. Therefore, the user cannot observe the fermentation of the compost.

Accordingly, the present invention proposes an environmental-protection kitchen-waste composting bag to overcome the abovementioned problems.

### SUMMARY OF THE INVENTION

The primary objective of the present invention is to provide an environmental-protection kitchen-waste composting bag, which is used to ferment kitchen waste, and which can separate kitchen-waste water from kitchen waste, whereby the kitchen-waste water can be recycled and poured back to kitchen waste, and whereby is accelerated fermentation of kitchen waste, and whereby kitchen waste can be fermented more fully.

Another objective of the present invention is to provide an environmental-protection kitchen-waste composting bag, which is transparent and allows the user to observe the state of fermentation anytime, and which exempts the user from packaging the compost with another plastic bag after fermentation.

A further objective of the present invention is to provide an environmental-protection kitchen-waste composting bag, which can be fabricated in a simple way and a low cost, and which can be folded into a small package favoring collection and transportation.

To achieve the abovementioned objectives, the present invention proposes an environmental-protection kitchen-waste composting bag, which comprises an opening, a first open/close member arranged in the opening, a partition line partitioning the bag into a kitchen-waste compartment accommodating kitchen waste and a liquid compartment receiving kitchen-waste water, a first hole formed on the partition line allowing kitchen-waste water to flow into the liquid compartment.

Below, embodiments are described in detail in cooperation with drawings to make easily understood the characteristics and accomplishments of the present invention.

### BRIEF DESCRIPTION OF THE DRAWINGS

FIG. 1 schematically shows a conventional kitchen-waste composting tank;

FIG. 2 schematically shows a first embodiment of the present invention;

FIG. 3 schematically shows an application of the first embodiment of the present invention;

FIG. 4 schematically shows a second embodiment of the present invention;

FIG. 5 schematically shows a third embodiment of the present invention;

FIG. 6 schematically shows a fourth embodiment of the present invention;

FIG. 7 schematically shows an application of the fourth embodiment of the present invention;

FIG. 8 schematically shows a fifth embodiment of the present invention;

FIG. 9 schematically shows a sixth embodiment of the present invention;

FIG. 10 schematically shows a seventh embodiment of the present invention;

FIG. 11 schematically shows an application of the seventh embodiment of the present invention; and

FIG. 12 schematically shows an eighth embodiment of the present invention.

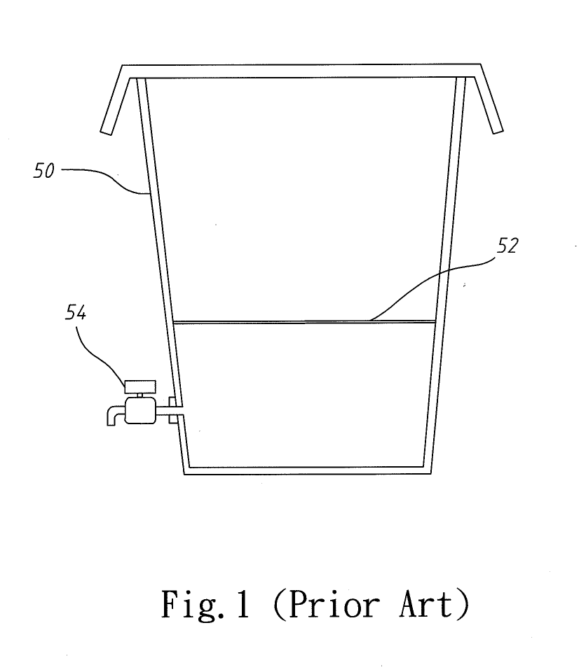

### DETAILED DESCRIPTION OF THE INVENTION

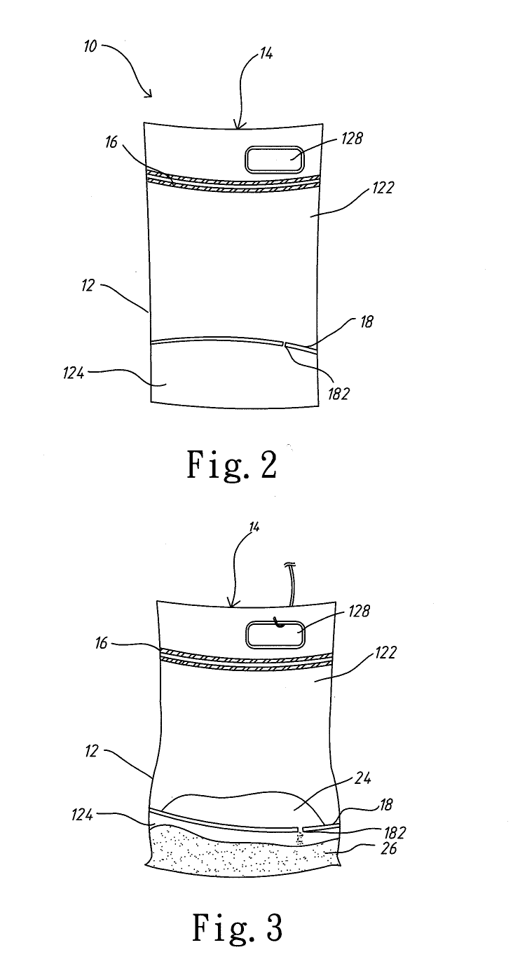

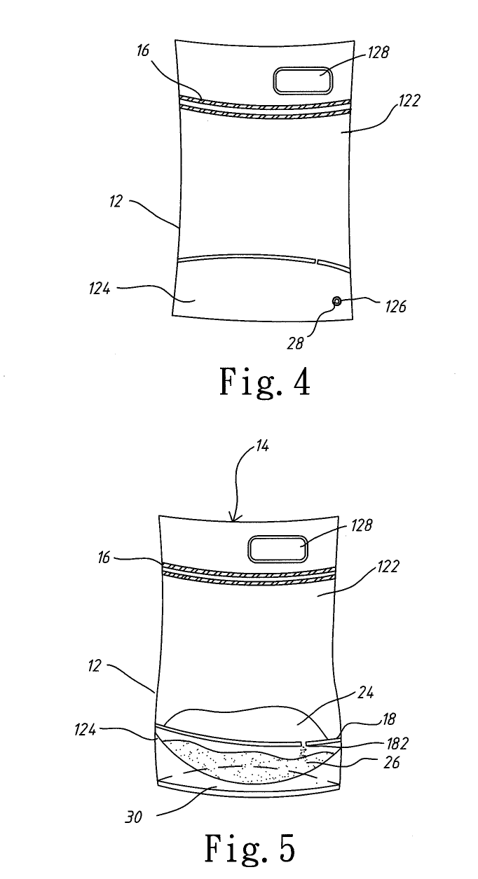

Refer to FIG. 2 and FIG. 3 for a first embodiment of the present invention. The environmental-protection kitchen-waste composting bag 10 of the present invention comprises a bag 12 and a partition line 18. The bag 12 is transparent and allows the user to see the interior of the bag 12. Therefore, the user can observe the state of fermentation of kitchen waste 24 inside the bag 12 conveniently. The bag 12 has an opening 14. The kitchen waste 24 is poured into the bag 12 for fermentation via the opening 14. The opening 14 has at least one first open/close member 16 able to open or close the opening 14. In the first embodiment shown in FIG. 2 and FIG. 3, the opening 14 has two first open/close members. In one embodiment, the first open/close member 16 is a ziplock. In one embodiment, the first open/close member 16 is a rope loop. The bag 12 has a handle member 128 the user holds to lift the bag 12. The bag 12 has a partition line 18 formed by hot pressing. The partition line 18 partitions the bag 12 into a kitchen-waste compartment 122 accommodating kitchen waste 24, and a liquid compartment 124 receiving kitchen-waste water 26. The kitchen waste 24 normally contains a great amount of kitchen-waste water 26. Therefore, a first hole 182 is formed on the partition line 18, allowing the kitchen-waste water 26 to flow into the liquid compartment 124. Refer to FIG. 3. The bag 12 is hanged from the handle member 128. Thus, the kitchen-waste water 26 in the kitchen-waste compartment 122 flows down into the liquid compartment 124. Suppose that the kitchen-waste compartment 122 and liquid compartment 124 are placed on a plane without any altitude drop existing therebetween. The kitchen-waste water 26 is hard to flow down into the liquid compartment 124. Therefore, in one embodiment, the bag 12 is hanged to allow the kitchen-waste water 26 in the kitchen-waste compartment 122 to flow into the liquid compartment 124 through the first hole 182. In one embodiment, the environmental-protection kitchen-waste composting bag 10 is placed on a brick with the liquid compartment 124 being lower than the top plane of the brick. Thus, the kitchen-waste compartment 122 is relatively higher than the liquid compartment 124. Then, the great amount of kitchen-waste water 26 in the kitchen-waste compartment 122 flows down into the liquid compartment 124 and separates from the kitchen waste 24. When the user intends to drain out the kitchen-waste water 26 in the liquid compartment 124, he may pierce a hole in the liquid compartment 124 to drain out the kitchen-waste water 26. Refer to FIG. 4 for a second embodiment of the present invention. In the second embodiment, a drain hole 126 is formed on the liquid compartment 124, and a switch member 28 is arranged on the drain hole 126. While the switch member 28 is opened, the kitchen-waste water 26 is drained out from the drain hole 126. Refer to FIG. 5 for a third embodiment of the present invention. In the third embodiment, a standing member 30 is arranged on the bottom of the bag 12. The standing member 30 can expand the bottom of the bag 12 and increase the base area of the bag 12, whereby the bag 12 can stand on a plane stably. Thus, the kitchen-waste water 26 in the kitchen-waste compartment 122 can flow into the liquid compartment 124 without hanging the bag 12 or placing the 12 on a brick. The other portion of the third embodiment is similar to the first embodiment and will not repeat herein.

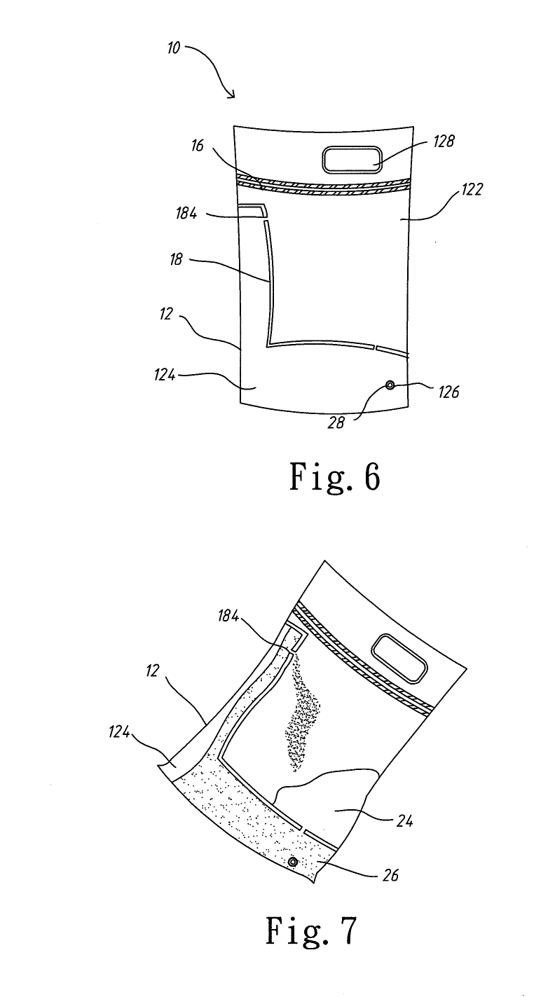

Refer to FIG. 6 for a fourth embodiment of the present invention. In the fourth embodiment, the partition line 18 is fabricated to have an L-like shape, whereby the liquid compartment 124 is extended to the upper portion of the bag 12. The upper portion of the partition line 18 has a second hole 184. The other portion of the fourth embodiment is similar to the second embodiment and will not repeat herein. Refer to FIG. 7 for an application of the fourth embodiment. While the user tilts the bag 12, the kitchen-waste water 26 in the liquid compartment 124 flows to the second hole 184 and then flows through the second hole 184 to the top of the kitchen waste 24 in the kitchen-waste compartment 122, whereby is accelerated fermentation of the kitchen waste 24.

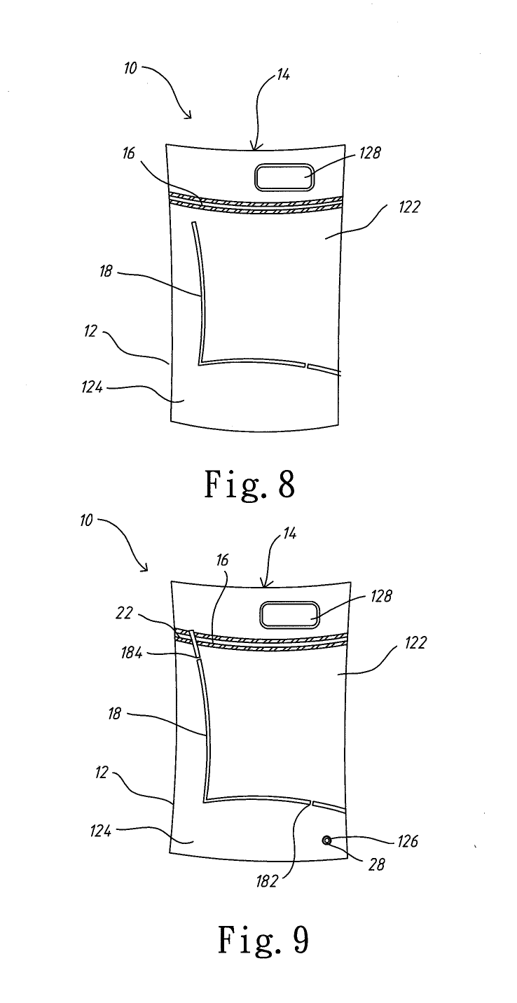

Refer to FIG. 8 for a fifth embodiment of the present invention. In the fifth embodiment, the liquid compartment 124 is extended to the opening 14 and shares the same opening 14 with the kitchen-waste compartment 122, whereby the kitchen-waste water 26 in the liquid compartment 124 can be drained out from the opening 14. In the fifth embodiment, the liquid compartment 124 also shares at least one first open/close member 16 with the kitchen-waste compartment 122. The fifth embodiment shown in FIG. 8 has two first open/close members 16. As the kitchen-waste water 124 in the liquid compartment 124 can reflow to the kitchen-waste compartment 122 via the opening 14, the second hole 184 is omitted. As the kitchen-waste water 124 in the liquid compartment 124 can be drained out via the opening 14, the drain hole 126 on the bottom of the liquid compartment 124 is also omitted. The other portion of the fifth embodiment is similar to the fourth embodiment and will not repeat herein.

Refer to FIG. 9 for a sixth embodiment of the present invention. In the sixth embodiment, at least one independent second open/close member 22 is arranged in the opening 14 of the liquid compartment 124. The sixth embodiment shown in FIG. 9 adopts two second open/close members 22. The second open/close member 22 may be in form of a ziplock or a rope loop. The other portion of the sixth embodiment is similar to the fifth embodiment and will not repeat herein.

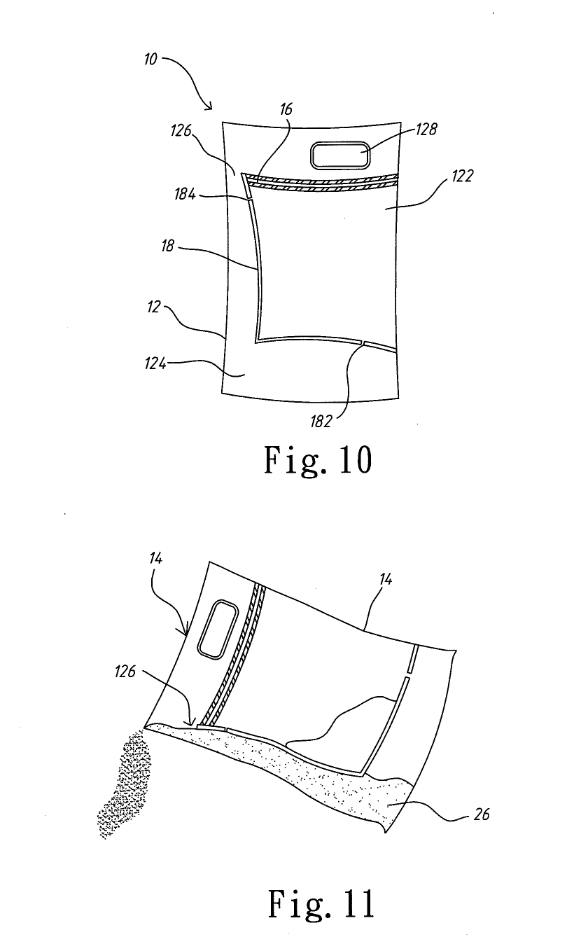

Refer to FIG. 10 for a seventh embodiment. In the seventh embodiment, the drain hole 126 is formed in the opening 14. The other portion of the seventh embodiment is similar to the fifth embodiment and will not repeat herein. Refer to FIG. 11 for an application of the seventh embodiment. Merely via tilting the bag 12, the user can drain out the kitchen-waste water 26 through the drain hole 126 in the opening 14 without piercing any hole.

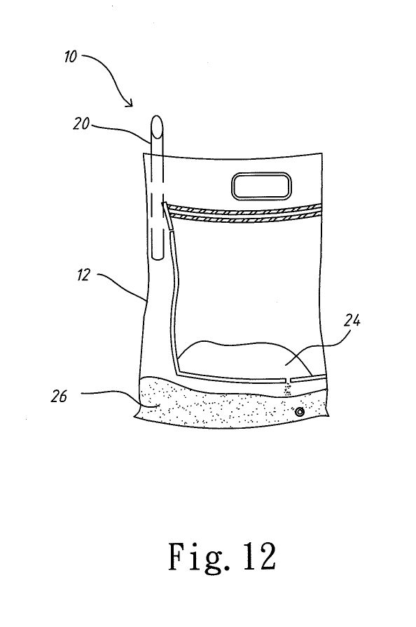

Refer to FIG. 12 for an eighth embodiment. While the kitchen waste 24 and the kitchen-waste water 26 are contained in the environmental-protection kitchen-waste composting bag 10, they would generate foul smell. In the seventh embodiment, an air-filter pipe 20 is inserted into the bag 12 to discharge the air inside the bag 12 and decrease the foul smell.

In addition to composting kitchen waste, the bag of the present invention may also be used to contain food, such as washed vegetables or leftovers. The user may place washed vegetables or leftovers in the bag to let water drip away and separate water from the vegetables or leftovers. Thus, food would not soak in water and is less likely to corrupt or denature.

In conclusion, the present invention can separate water from kitchen waste. Further, the present invention can recycle kitchen-waste water and pour the recycled kitchen-waste water back to the kitchen waste to acceleration fermentation of the kitchen waste. Furthermore, the transparent bag of the present invention allows the user to observe the state of fermentation anytime. Moreover, the user of the present invention needn't pack the composted kitchen waste any more. Additionally, the present invention can be fabricated in a simple way and a low cost and can be folded into a small package favoring collection and transportation.

In conclusion, the embodiments described above are only to exemplify the present invention but not to limit the scope of the present invention. Any equivalent modification or variation according to the characteristic or spirit of the present invention is to be also included within the scope of the present invention.

What is claimed is:

1. An environmental-protection kitchen-waste bag comprising
a bag having an opening, wherein at least one first open/close member is arranged on said opening for opening or closing said opening; and
a partition line formed inside said bag and partitioning said bag into a kitchen-waste compartment accommodating kitchen waste and a liquid compartment positioned below said kitchen-waste compartment and receiving kitchen-waste water, wherein said partition line has at least one first hole allowing water in said kitchen-waste compartment to flow into said liquid compartment.

2. The environmental-protection kitchen-waste bag according to claim 1, wherein said liquid compartment is extended to said opening to enable water in said liquid compartment to flow out from said opening.

3. The environmental-protection kitchen-waste bag according to claim 2, wherein said opening for said liquid compartment has at least one second open/close member.

4. The environmental-protection kitchen-waste bag according to claim 2, wherein said second open/close member is a ziplock or a rope loop.

5. The environmental-protection kitchen-waste bag according to claim 1, wherein said first open/close member is a ziplock or a rope loop.

6. The environmental-protection kitchen-waste bag according to claim 1, wherein said bag has a handle member.

7. The environmental-protection kitchen-waste bag according to claim 1, wherein a drain hole is formed in said liquid compartment to drain out water in said liquid compartment.

8. The environmental-protection kitchen-waste bag according to claim 7, wherein a switch member is arranged on said drain hole.

9. The environmental-protection kitchen-waste bag according to claim 1 further comprising an air-filter pipe inserted into said bag to discharge ferment gas inside said bag.

10. The environmental-protection kitchen-waste bag according to claim 1, wherein said bag is transparent.

11. The environmental-protection kitchen-waste bag according to claim 1, wherein said liquid compartment has a second hole allowing water in said liquid compartment to flow back to said kitchen-waste compartment.

12. The environmental-protection kitchen-waste bag according to claim 1, wherein said partition line is fabricated to have an L-like shape.

13. The environmental-protection kitchen-waste bag according to claim 1, wherein a standing member is arranged in a bottom of said bag, expanding said bottom of said bag to enable said bag to stand on a plane.
